(19) United States
(12) Patent Application Publication
(10) Pub. No.: US 2011/0202555 A1
(43) Pub. Date: Aug. 18, 2011

(54) Graphical User Interfaces Supporting Method And System For Electronic Discovery Using Social Network Analysis

(75) Inventors: Mark A. Cordover, Washington, DC (US); Andrew Liu, Clarksburg, MD (US); Seth Green, Takoma Park, MD (US); Jonathan Bodner, Potomac, MD (US); Sundara S. Chintaluri, Oak Hill, VA (US); Aron Culotta, New Orleans, LA (US)

(73) Assignee: IT.COM, Inc., Washington, DC (US)

(21) Appl. No.: 13/010,304

(22) Filed: Jan. 20, 2011

Related U.S. Application Data
(60) Provisional application No. 61/299,034, filed on Jan. 28, 2010.

(51) Int. Cl. G06F 17/30

(52) U.S. Cl. 707/769; 707/E17.014

(57) ABSTRACT

A method, for use in a user computer system including a pointing device and a visual display unit, for providing a graphical user interface to a computer program for electronic discovery of information, wherein the information is stored in a database, and wherein the information has been preprocessed using social network analysis to find social network relationships between items of the information, and wherein topics are determined using distributed Latent Dirichlet Allocation (LDA)

### RELATED APPLICATIONS

This application is related to and claims priority from co-pending U.S. Provisional Patent Application No. 61/299,034, filed Jan. 28, 2010, and titled “Graphical user interfaces supporting Method and System for Electronic Discovery Using Social Network Analysis,” the entire contents of which are fully incorporated herein for all purposes.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever.

### FIELD OF THE DISCLOSURE

This invention relates to electronic discovery of information, and, more specifically, to graphical user interfaces supporting electronic discovery using social network analysis.

### BRIEF DESCRIPTION OF THE DRAWINGS

The following description, given with respect to the attached drawings, may be better understood with reference to the non-limiting examples of the drawings, wherein:

FIG. 1 depicts a typical system on which embodiments of an electronic discovery system operate;

FIG. 1(b) is a diagram describing the flow of the ART-LDA phase; and

FIGS. 2 to 8 depict various interface displays of an electronic discovery system during its operation.

### THE PRESENTLY PREFERRED EXEMPLARY EMBODIMENTS

### Introduction & Background

The discovery process in litigation and other investigations has typically been a linear process, where large numbers of documents are reviewed and analyzed for their relevance and to obtain information. The process typically involves reviewing 1000s of printed pages of text. However, the fact that many documents are now stored electronically, and either produced from native files or the fact that much discovery is now done on scanned versions of documents, has not changed the nature of the discovery process—it is carried out linearly.

However, in the world of linear review, where all documents are “created equal” there is necessarily an enormous amount of wasted time. Given a large warehouse of unmarked boxes, one has no choice but to read every document in any order.

The inventors realized that a system was needed to avoid the need for linear review. The inventors realized that in the real world, not all documents are created equal with respect to the focus of any particular investigation, or, more broadly, that “context” is important for understanding “text”. The inventors realized that who says something can matter as much as what is said, and that when something is said is often seminal. To this end, the inventors realized that a discovery review system should support topical categorization techniques, and that such was the key to non-linear review.

So called “supervised” learning technology—machines using training sets of data as samples—is also incorporated into the system. From a small sample set, the system can generate a likely set of non-responsive or responsive or any other “kind” of document. Senior reviewers can choose to hide non-responsive documents from results so as to quickly focus their attention on documents most likely to be responsive. At any time, corrections can be made and corpus reduction can be run again to improve results.

Prior search technology uses at most two axes with which to form a query. The present system offers three axes: via topic modeling, the user (reviewer) has an idea of what is discussed. Through the choice of custodians or author/recipients, the user obtains a precise expression of who discussed that topic. In addition, through traditional keyword search, the user can demand that certain words be used in some specified way.

The need for special tools to search particularly email among all of electronically stored information (ESI) arises from the unique nature of email and its unique importance.

Email is different from other electronic documents because it is sent among people who are usually unambiguously identifiable. It is impossible to send email (or receive it) without a unique email address. Such data are sometimes called “structured” data. Email is “semi-structured” since the body of a text (and subject lines) can contain any free-form series of words or even images (called unstructured data). Because email is sent and received among people who typically know each other, and because the email is about things related to them insofar as they know or work together, email reflects a social network. Within an enterprise, the social network is reflective of activity in that enterprise. The inventors realized that, not only can you get at the social network through email, but also that the corpus of email as a whole often reflects nearly everything that is going on in the enterprise. The vast majority of electronic documentation in an enterprise is in the form of email (75 to 80 percent), but more importantly, the content of that email is comprehensive, up to date and deep. However, there is a problem in data mining email. Email is “noisy”. Very frequently searching email yields false positives and false negatives.

The inventors realized that the primary difficulties inherent in searching emails—its sheer volume and its “noisy” nature—are susceptible of recent developments in machine learning technologies that make this task manageable. The present system began with this problem and with these recent advances in machine learning technologies.

The sheer volume of email and its “noisy” nature makes searching by any traditional means a futile task. Keywords necessarily lead the reviewer astray, and treating email like it was just like any other form of unstructured data is generally a fatal flaw (email is often a response to another email or a solicitation for such a response). For that and other reasons “search” often means manual review, especially in high-stakes litigation or in a regulatory context. It has been estimated that it would take 100 people working 10 hours per day, 7 days per week, 52 weeks per year, fifty-four years to read just one year's production of email from a large enterprise, at an estimated cost of $2 billion. Moreover, the numbers are growing every day.

Time and money aside, such a review would be done poorly and likely be error prone.

Traditional email e-discovery is broken, yet in nearly all contemporary forensic investigations involving enterprises, email has proven to be the source of the most salient discoveries. Most attempts at intelligent search use either word overlap methods or lightweight natural language processing but neither is very effective, though each add value. The inventors realized the importance of topic modeling—the creation of a third axis with which to search—either manually or automatically (or both).

### Keywords

It is common for opposing parties in litigation to negotiate which keywords shall form the basis for an agreed upon production of documents in the course of complying with document requests. Keywords are used because they are commonly understood as an input to a search engine which brings back documents containing those words.

Attempts have been made to come up with a more scientific or at any rate rigorous means of choosing those keywords. For example, in “Improving Search Effectiveness in the Legal E-Discovery Process Using Relevance Feedback”, the authors, Feng Zhao, et al., begin from the premise: “keyword based search dominates current legal practice in e-discovery as it is well understood and has been commonly used by the legal community for a long time. However, it is difficult for a party to select the right keywords”. They go on to suggest an iterative process for the party with less knowledge than the opponent to get as much as they can given their naturally weaker position. The goal is simply justice or fairness which means that relevant documents get produced.

Some systems market themselves as using “concept searching” or “meaning based” searching However, these are marketing terms with no real technical meaning.

In addition to words or phrases or proximity matches, one often can glean context from metadata in electronic documents. So frequently one knows the author of a document, frequently the recipient and its date, and one could infer from co-occurrence of words all sorts of similarities that constitute intelligent groupings of documents. From these groupings, one gains the most important thing in search: context. The inventors realized that if one could generalize this process of placing into discrete bins various groupings of similarly structured patterns of words informed by their authors and recipients, one would have what is referred to as topic modeling that is exceptionally powerful in any text mining exercise. With topic modeling, keywords would show not just “hits’ but “hits” about what, and also among whom and when. The iterative approach to the use of keywords is made much more intelligent by the use of topic modeling.

Three axes against which to search make it possible to triangulate a search, bounded by who, what, and with which key words, or by when something took place.

### DESCRIPTION

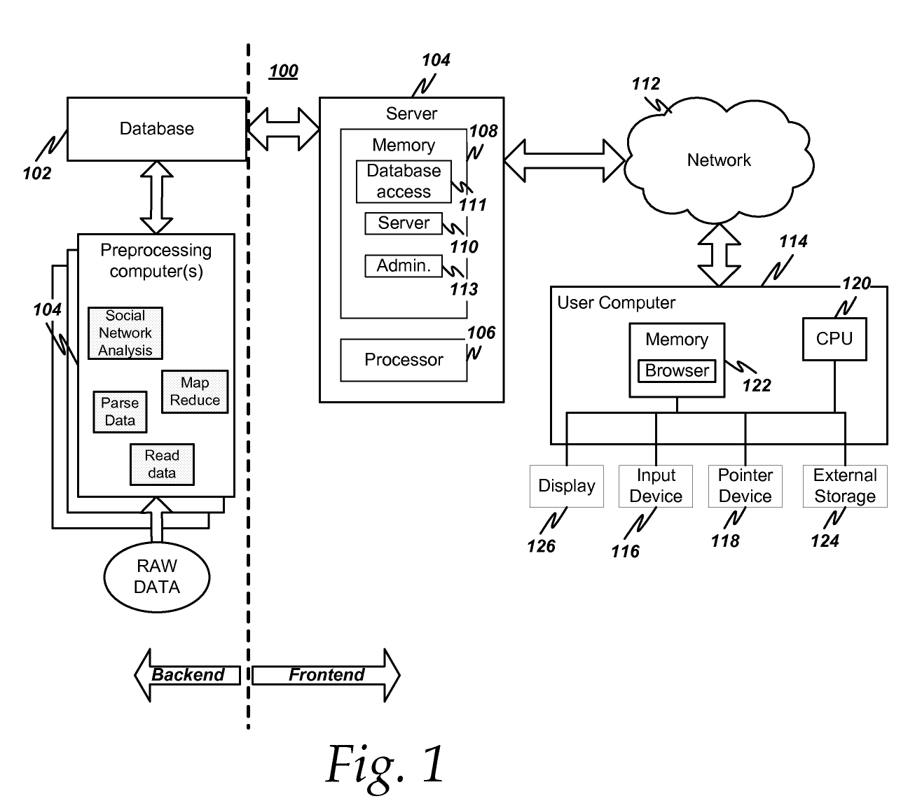

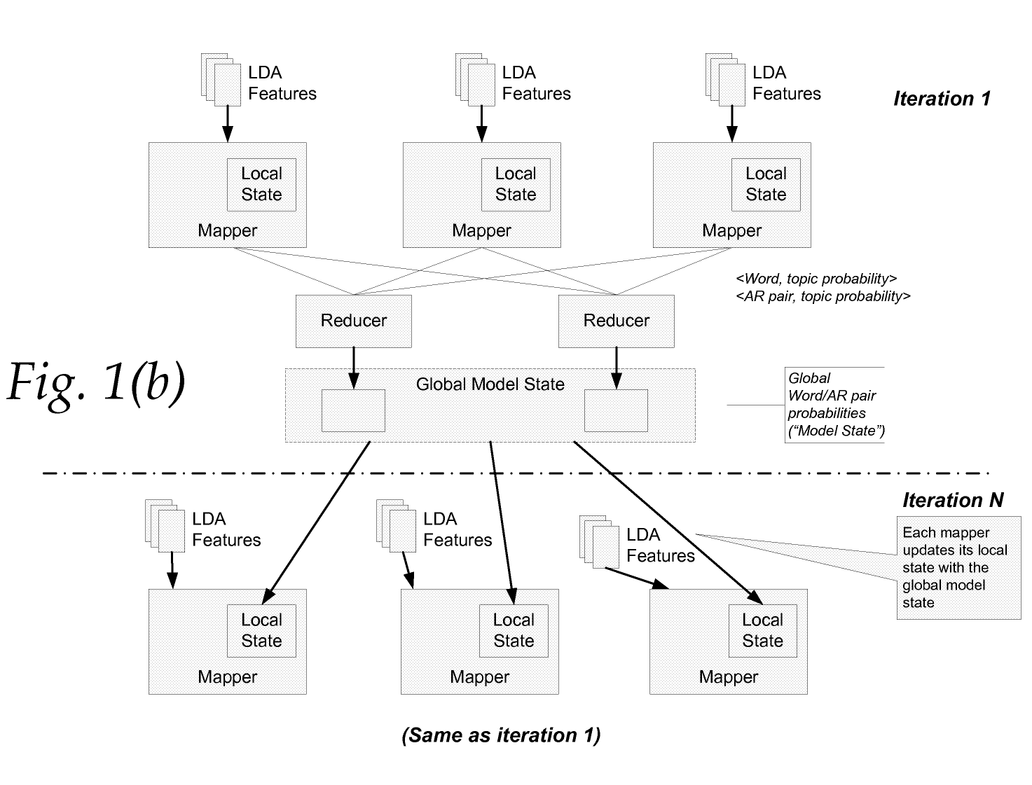

FIG. 1 is an overview of an electronic discovery system 100 using social network analysis in combination with traditional search techniques. For the purposes of this description, as shown in FIG. 1, an electronic discovery system 100 can be viewed in two parts, a backend in which raw data are pre-processed for inclusion in a database 102, and a frontend which provides end-users access to the database 102. Those skilled in the art will realize upon reading this description, that the distinction between the backend and the frontend is for descriptive purposes only.

As used herein, the term “raw data” refers to the data in their original form. The data may be e-mails, text documents, and the like. In general, the raw data refer to the discovery corpus. Those of skill in the art will understand, upon reading this description, that the system is not limited by the nature or format of the raw data. In presently preferred embodiments the raw data represent electronic mail (e-mail) messages and other documents (including documents attached to emails), and the following description is made with reference to e-mail examples. Those skilled in the art will understand, upon reading this description, that the electronic discovery system can operate on other forms of raw data (including without limitation text documents and the like), and that the raw data may be combinations of documents, emails, and other forms of data.

The backend consists of one or more preprocessing computers 104 that process raw data 106 and add those data to the database 102 in a form suitable for searching using a combination of traditional search techniques and social network analysis. The preprocessing of the raw data is described in detail below.

On the frontend, users are provided access to the database 102 via one or more servers 104 using a graphical user interface (GUI) described in detail below. The server 104 may be a typical server with a processor 106 and memory 108. Server software 110 operates in the processor 106 and memory 108 of the server 104 to perform the server functions. In a present implementation, the server is a virtual machine in a VMW environment. The server 104 also includes database access software 111 to perform database access functions required by the electronic discovery system 100. The server 104 has access to the database 102 via the database access software 111, and can perform database queries in response to user requests. In a present implementation, the database access software 111 is MySQL.

The server 104 also preferably includes administrative software 113 to control and monitor access to the database 102.

While the system is described herein with reference to a single server, those of skill in the art will realize and understand, upon reading this description, that multiple servers may be used in the system.

In presently preferred embodiments, end users preferably access the database 102 via a network 112 such as the Internet. More specifically, in operation, end-user computers 114 use a browser and the GUI (described below) to accesses/query the database 102 via the network 112 and server 104. End users can access the system via the appropriate web sites using a typical computer system which includes various input devices 116 such as a keyboard, and a pointer device 118 (such as, e.g., a mouse, track ball, touch screen, keyboard cursor control keys or the like). The end user's computer system 114 also includes a processor such as CPU 120 and internal memory 122. The processor may be a special purpose processor with image processing capabilities or it may be a general-purpose processor. The memory may comprise various types of memory, including RAM, ROM, and the like. The computer system may also include external storage 124 which includes devices such as disks, CD ROMs, ASICs, external RAM, external ROM and the like.

Various security measures (e.g., encryption, virtual private networks (VPNs) and the like) may be implemented to secure remote access to the database.

The users' computer(s) 114 also includes an appropriate display 126 and, optionally, an output device such as a printer (not shown). It is well understood in the art that when a user accesses a web site, information from that web site may be displayed on the display screen of the user's computer. It is further well understood in the art that users may interact with a program using a graphical user interface (GUI) and the user's pointer device(s) and/or keyboard.

The computer(s) 114 may be any general purpose or special purpose computer(s) that can access the server. Aspects of the present invention can be implemented as part of the processor or as a program residing in memory (and external storage) and running on processor, or as a combination of program and specialized hardware. When in memory and/or external storage, the program can be in a RAM, a ROM, an internal or external disk, a CD ROM, an ASIC or the like. In general, when implemented as a program or in part as a program, the program can be encoded on any computer-readable medium or combination of computer-readable media, including but not limited to a RAM, a ROM, a disk, an ASIC, a PROM and the like. The computer(s) 104, 114 can run any operating system.

Those of skill in the art will understand, upon reading this description, that users may access the system using any browser-enabled device with sufficient display capabilities. All references in this description to any computer system used by any user include any such browser-enabled device.

While only one user computer is shown in the drawings, those of skill in the art will understand, upon reading this description, that multiple users may access the system at the same time using multiple computers.

### Backend Processing

With reference to FIG. 1, raw data input to the system is preprocessed (by preprocessing computer(s) 104) and provided to database 102. In the case of data such as e-mail data which may come from diverse sources and may be in different forms, it is necessary to put these data into a common form. A reader program reads the raw data and converts the data to a common form for subsequent processing.

Next, the data in common form are parsed into objects in the system's data model. This creates an internal representation of the data for use by subsequent processing and by the front-end (for searching).

Social network analysis (“SNA”) is then carried out on the data. The term “social network analysis” (or “SNA”), as used here, refers to the derivation of probabilistic role information from quantitative and sometimes directional, data on communications between individuals. The SNA preferably uses an Author-Recipient-Topic (ART) model, which learns topic distributions based on the messages sent between entities. A description of a technique for ART is given in “Topic and Role Discovery in Social Networks with Experiments on Enron and Academic Email,” by Andrew McCallum, et al., Journal of Artificial Intelligence Research 30 (2007) 249-272, the entire contents of which are fully incorporated herein for all purposes.

The ART model builds on Latent Dirichlet Allocation (LDA), a learning algorithm for automatically and jointly clustering words into “topics” and documents into mixtures of topics. LDA was described in Blei, D. et al., Latent Dirichlet allocation, The Journal of Machine Learning Research, 3, p. 993-1022,Mar. 1, 2003, the entire contents of which are fully incorporated herein by reference for all purposes.

As used herein, a “Topic” is a multinomial distribution over words. These distributions may often correlate to human-identifiable topics such as “meetings”, “personal communications”, or “football”. However, they are derived mathematically from the data, and as such will vary according to the data's content.

As used herein, an “SNA-weighted topic” refers here to a topic, in which the distribution over words is calculated by incorporating information derived from SNA.

Those skilled in the art will also understand that the social network analysis may not be performed on all of the raw data.

In addition, the data are indexed. In a presently preferred implementation, the data are indexed using Apache Lucene (Apache Lucene is a high-performance, full-featured text search engine library written entirely in Java. It is publicly available as an open source product from “http://lucene.apache.org”.)). The data are processed using map/reduce programs executed in Hadoop. Map/reduce is the style in which all programs running on Hadoop are written. In this style, input is broken in small pieces which are processed independently (the map part). The results of these independent processes are then collated into groups and processed as groups (the reduce part).

Thus, in preferred implementations, the search architecture supports corpus sharding—that is, splitting a corpus of documents into many smaller chunks, and searching them at the same time. This approach supports scaling the system to very large data sets using off the shelf commodity hardware.

It is often the case that a particular person will use more than one email address or go by more than one name within an enterprise. The system thus provides a mechanism for name normalization, so that a person who uses multiple identifiers (email addresses, etc.) will not be treated by the system as two different people. Name normalization groups alternate email addresses and spellings into one correspondent, to reduce the number and complexity of searches and improve visibility into the corpus. The system also allows users to manually group different names.

Topic Affinity Scores:

To derive a set of K topics from a set of email documents, the system relies on a probabilistic model built from a Bayesian Network. The model defines the joint probability of a document D, set of words W, topics T, sender S, and recipient R. Each word in each document is assigned a sender, recipient and topic. The topic assignment is an unobserved variable which is estimated by maximizing the likelihood of the observed data. The topic distribution is a multinomial over words.

For each topic, there is a different multinomial for each sender/recipient pair. The topic multinomials are in turn drawn from a Dirichlet distribution with hyper-parameter alpha. Because exact estimation is intractable for this Bayesian Network, the system uses Gibbs sampling, a stochastic estimation method that iteratively updates the topic assignments to improve the data likelihood.

Once all words have been assigned topics, we have finished estimating the parameters of the joint distribution. Given the joint distribution, we can perform marginalization to obtain two distributions that are useful for the application:

Topic distribution T(i): A multinomial distribution over each word for a single topic i, marginalizing out all possible senders and recipients. This is computed for each topic to get the “Topic View” of the application. For each topic i, words in that topic are ranked according to this probability.

Document-Topic Distribution D(i): A distribution over Topics for document i. This is computed in order to compute the “topic affinity” of each document. When a user searches documents containing topic i, documents are ranked by this probability.

Scaling and Distributing SNA:

The Distributed SNA Phase.

The present system implements distributed SNA, thereby supporting scalability and topic determination over extremely large collections of documents. An approach to distributed LDA is provided by Newman, D., et al, Distributed inference for Latent Dirichlet allocation. Neural Information Processing Systems (NIPS), 20: 1081-1088, December 2007, the entire contents of which are fully incorporated herein by reference for all purposes.

FIG. 1(b) is a diagram describing the flow of the SNA phase in a presently preferred implementation. First, feature extraction is performed on the corpus. A routine (FeatureExtractorMapReduce) examines the corpus, and for each document, filters out noise and tokenizes the text. Noise refers to any portions of text in a document that has no semantic meaning, for example, email signatures, machine-generated text, and legal disclaimers. The tokenized text of each document is stored as a Features object in a SequenceFile. (A SequenceFile is a Hadoop-specific disk-based data structure, which stores serialized objects. It is not indexed in any way, so it is essentially a stream of arbitrary binary bytes with delimiters indicating record boundaries.) Without this filtering step, the system may end up with many topics formed around these noisy sections of text.

Next, an alphabet is created. A routine (CreateAlphabetMapReduce) examines every Features object and creates an alphabet, which consists of every single unique word, as well as every single unique author-recipient (AR) pair in the corpus. Each unique word and AR pair is assigned a sequential integer ID. The alphabet is stored on disk as a SequenceFile. In subsequent steps, all words and AR pairs are expressed in terms of their respective IDs, to improve space efficiency.

The dataset is then partitioned—the Features SequenceFiles are partitioned by sender. This ensures that when each mapper runs its own local SNA process the data examined will contain shared senders, which results in a more numerically efficient sampling process. The partitions are stored as SequenceFiles. Without this step, SNA might not converge within a reasonable number of iterations.

Each map process then runs SNA on a range of documents (represented by Features objects). SNA estimates the model using a Gibbs sampling procedure. (Gibbs sampling is an approach to generate a sequence of samples from the joint probability distribution of two or more random variables.) Each mapper (running independently) runs the sampling procedure for a preset number of iterations. In order to obtain a global set of topics across the entire corpus, data from each local mapper's model needs to be joined. This is done in the reduce phase. In the reduce phase, word to topic probabilities, as well as author-recipient to topic probabilities are pooled together, creating the global model state. In subsequent iterations, each mapper updates its own local model with the global model state.

The entire map/reduce process is repeated for a preset number of iterations. In a presently preferred implementation, 500 iterations are used.

Once the system has determined a set of topics, those topics may be named (by a user) in order to provide meaning to document reviewers.

Frontend Processing

The frontend operates on data that have been processed and indexed and stored in the database 102. The following description describes certain flows that take place through the system during operation, along with the user interface (GUI) screens that are displayed during processing. As is well known in the art, a user navigates through screens by selecting appropriate regions on the screens (e.g., buttons, text or the like). Although the term “click” is often used herein to describe this navigation process, those skilled in the art will immediately understand that any form of selection can be used.

The drawings provide exemplary screen shots of embodiments of the graphical user interface of the present invention. Those skilled in the art will immediately understand, upon reading this description, that these screen shots are exemplary, and that different and/or other screens may be used and are within the scope of the invention.

In a presently preferred embodiment, the browser supports HTML, the JavaScript programming language, and Adobe Flash to implement aspects of the GUIs described herein.

The GUI preferably offers the user four distinct visual panels, for each of four primary attributes of any document:
Author/recipient information
Temporal data. For example, “Date sent”
SNA-weighted topic information (the subjects discussed in the document, as these are informed by the distribution over topics of the sender-recipient pair)
Textual data (such as email subjects, document titles, email or document body text)

The GUI also enables the construction of searches which include any or all of the following document characteristics:
SNA-weighted topic membership
Keywords
Document metadata field values (including, but not limited to: date/time, author/recipient, file type, email domain, manual classifications).

The GUI enables the real-time and interactive display of all the document characteristics; enabling further, iterative, filtering by any of these characteristics.

Given an SNA-weighted topic, the GUI provides an ordering of senders and recipients, based on a score that incorporates both (i) how many documents they authored or received in a particular SNA-weighted topic, and (ii) a measure of how well those documents were described by a particular SNA-weighted topic.

User requests are sent to the server which prepares and returns an appropriate response.

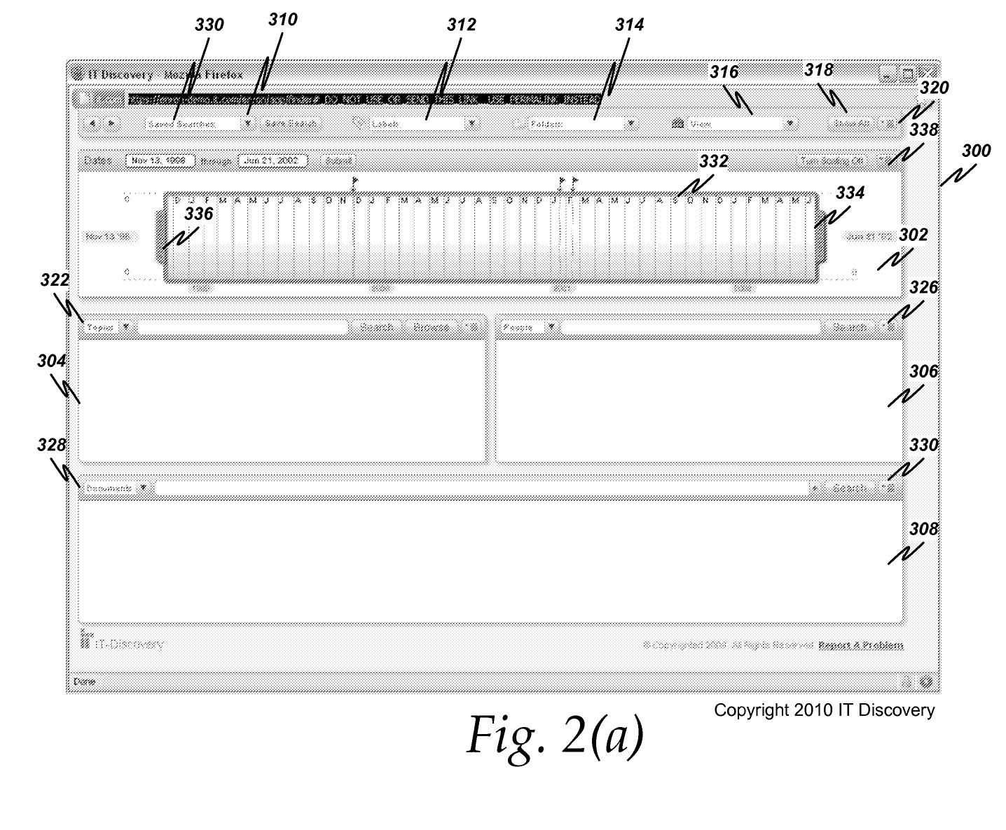

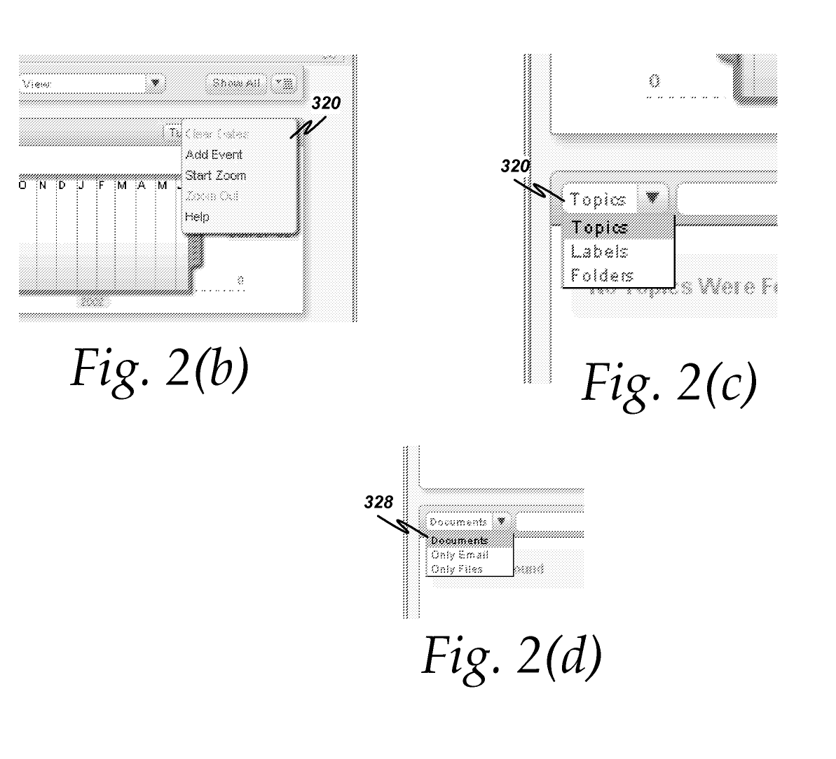

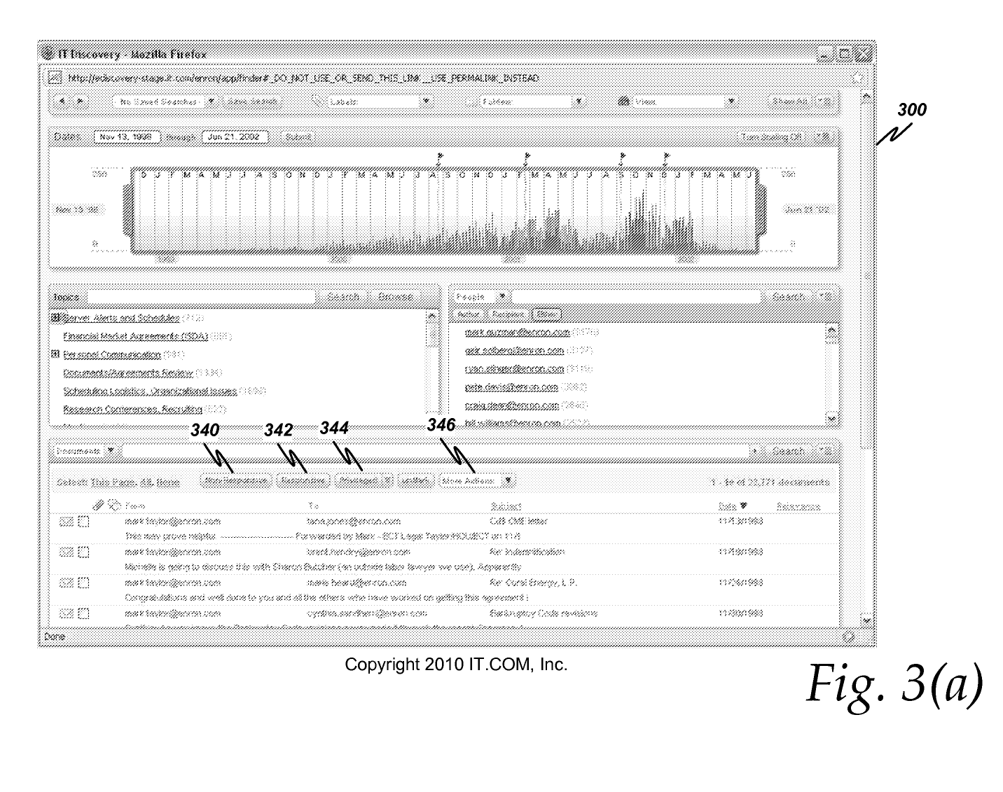

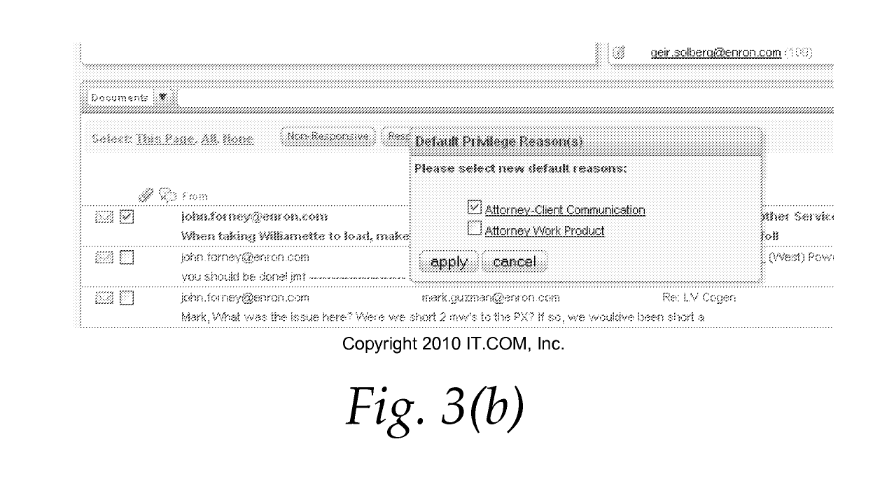

Accordingly, in a presently preferred implementation, the GUI 300 (FIG. 2(a)) has four main regions (or panels or boxes), namely the timeline 302, the “Topic” region 304, the “People” region 306, and the “Document” region 308. In addition, the GUI 300 provides various browsing and annotation tools, including a “Save Search” control button 310, a “Labels” control 312, a “Folders” control 314, a “View” control 316, and a “Show All” control 318. A drop-down menu 320 provides additional controls (shown in detail in FIG. 3(b)). As shown in FIG. 3(b), menu items that are not applicable to the current view are grayed and are not available.

Users are preferably registered with the system, and the system implements various security features to control and monitor access to the database 102. Once a user is logged in, the user is presented with an Admin Screen which allows the user to set or modify various administrative options. The user is also presented with a button to launch the Discovery Application. The user selections this button to launch the application. The user is then presented (on display 126) with the GUI 300 shown in FIG. 2(a). There are, as yet, no data presented.

A drop-down menu 322 provides additional controls (shown in detail in FIG. 3(c)) for the topic region 304. A drop-down menu 324 provides additional controls for the People region 306. A drop-down menu 328 (shown in detail in FIG. 3(d)) provides additional controls for the Document region 308.

The GUI 300 is the standard top-level user interface to the database 102. The Document region 308 shows all documents that satisfy then-current search criteria. The Topic region 304 is used to view and/or categorize documents by various user-defined topics. When the system is started, the GUI 300 displays no data. The user can then display all of the data (unfiltered) using the “Show All” button 318. The user can also load previously saved searches using the “Saved Searches” selector 330. If previous searches have been saved (using the “Save Search” button 310), then those searches will be available under the “Saved Searches” selector 330. This mechanism allows users to save and share searches with other users.

FIG. 3(a) is an example of the GUI 300 populated with data after the “Show All” button 318 has been selected. (The database used for the following examples is derived from publicly available email and documents from Enron in November 1998 to June, 2002. The Enron email corpus used in the examples is a subset of a body of email messages subpoenaed as part of the investigation of Enron by the Federal Energy Regulatory Commission (FERC), and then placed in the public record. The original data set contains 517,431 messages; however, analysis show only 250,484 of these messages to be unique.)

As can be seen from FIG. 3(a), once the “Show All” button 318 is selected, the Topics Region 304, People Region 306, and Document Region 308 are populated with information. The timeline region 302 contains a timeline 332 which provides both a tool to filter the database (between two dates), and a graphical indication of the number of documents satisfying the current query.

Each document in the data corpus is represented by a pixel in the Timeline Box 332. The pixels corresponding to emails sent (or documents created) on the same date will stack, much like a bar graph, giving a visual representation of communication patterns over a given period of time.

The timeline box 332 is updated whenever the search results change, and thus the timeline box displays, at all times, a running graph of the document results being displayed.

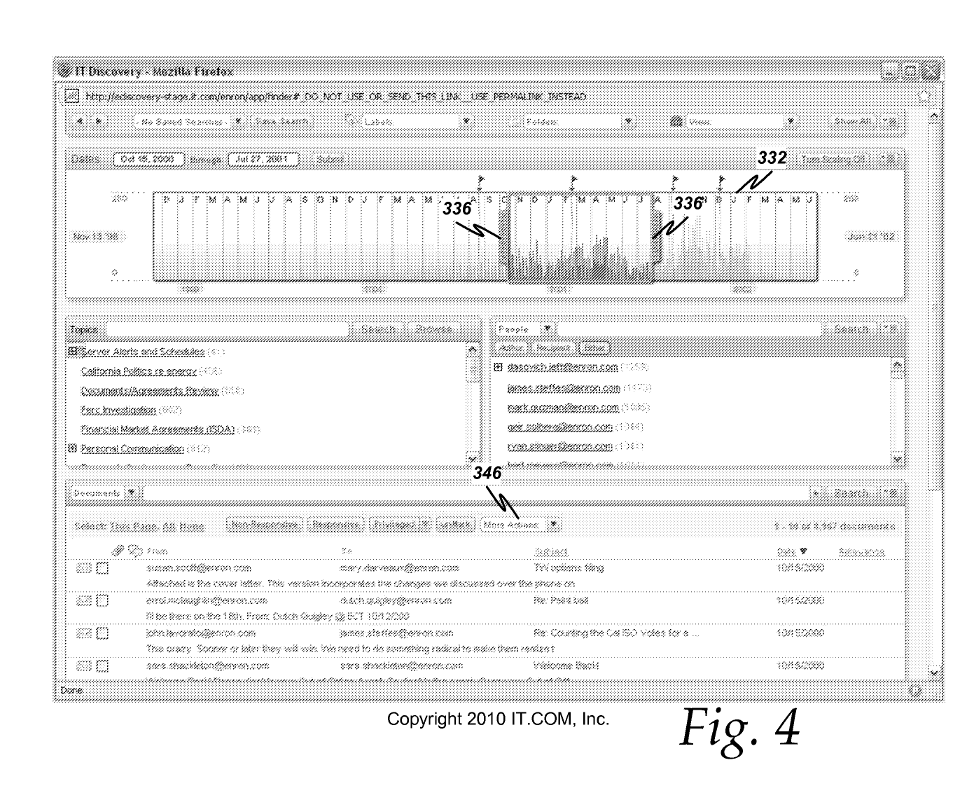

In addition to providing search summary information (in the form of a histogram), the timeline box 332 can be used to filter the search data in a number of ways. For example, either or both of the end handles 334 and 336 can be selected and dragged to created a different time period (e.g., as shown in FIG. 4). The user can also use the “Zoom” selection from the drop down menu 338 to zoom in on a specific region of the timeline. When the user selects the “Zoom” menu option, the cursor changes shape and the user is able to click and drag over a section of the timeline to focus on that section.

The Topic Region 304 displays the most relevant topics to a document set. Selecting a topic in the Topic Region 304 will make the People region and the Document region display the people and documents relevant to that topic. Searching in the Topic Region 304 will produce topics most substantively related to the search terms and not topics whose titles contain those words in the user's search. A user can search over multiple topics in the topic list. To do so the user must hold the control key while clicking each topic selected.

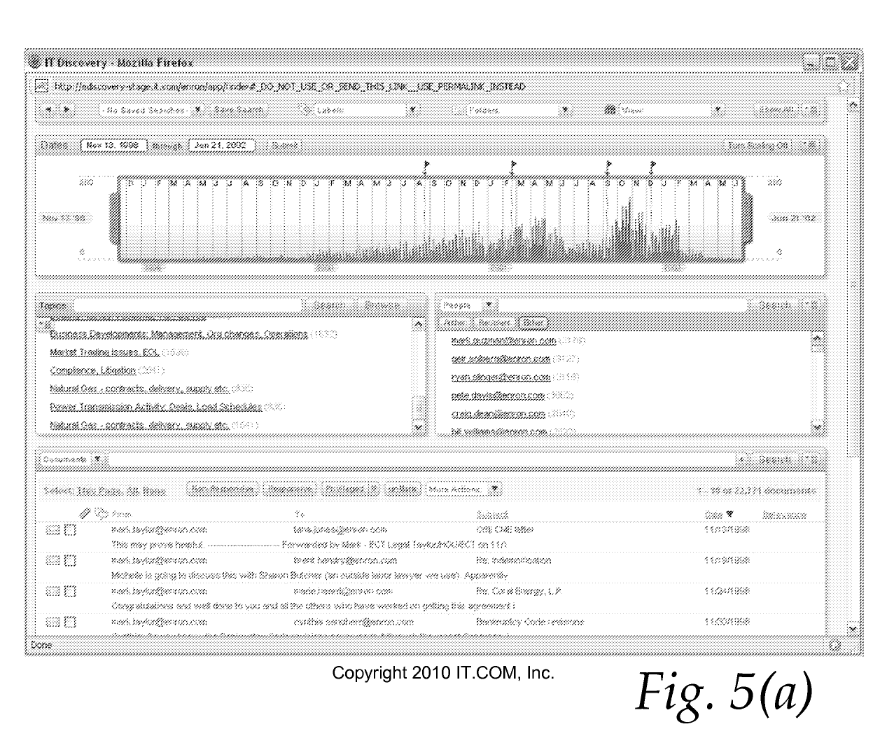

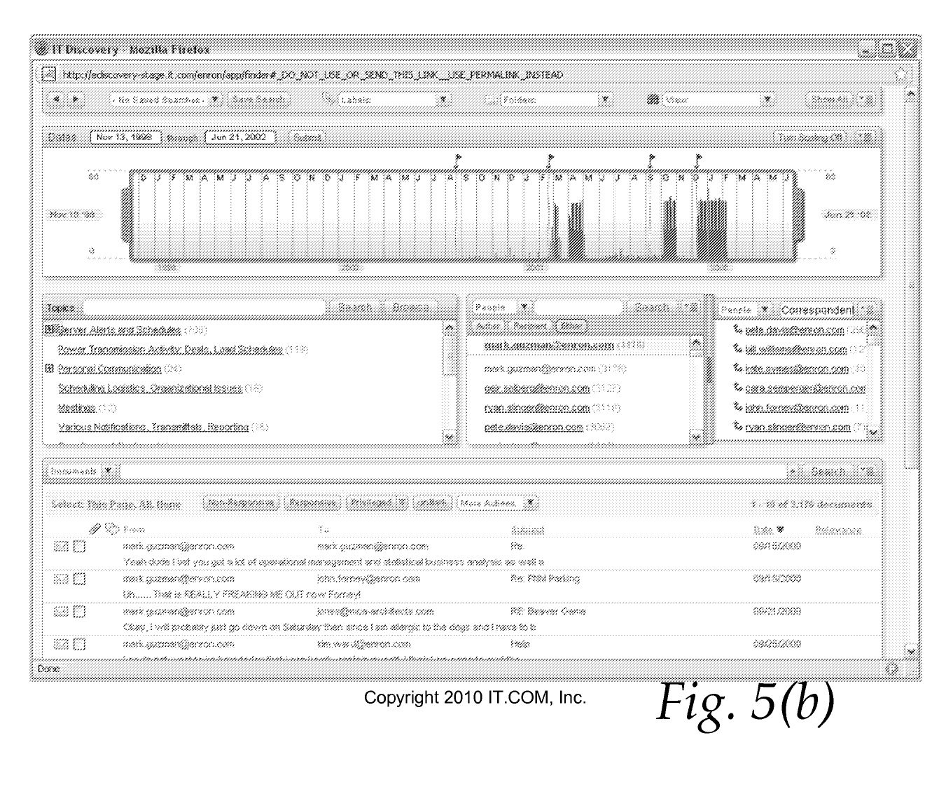

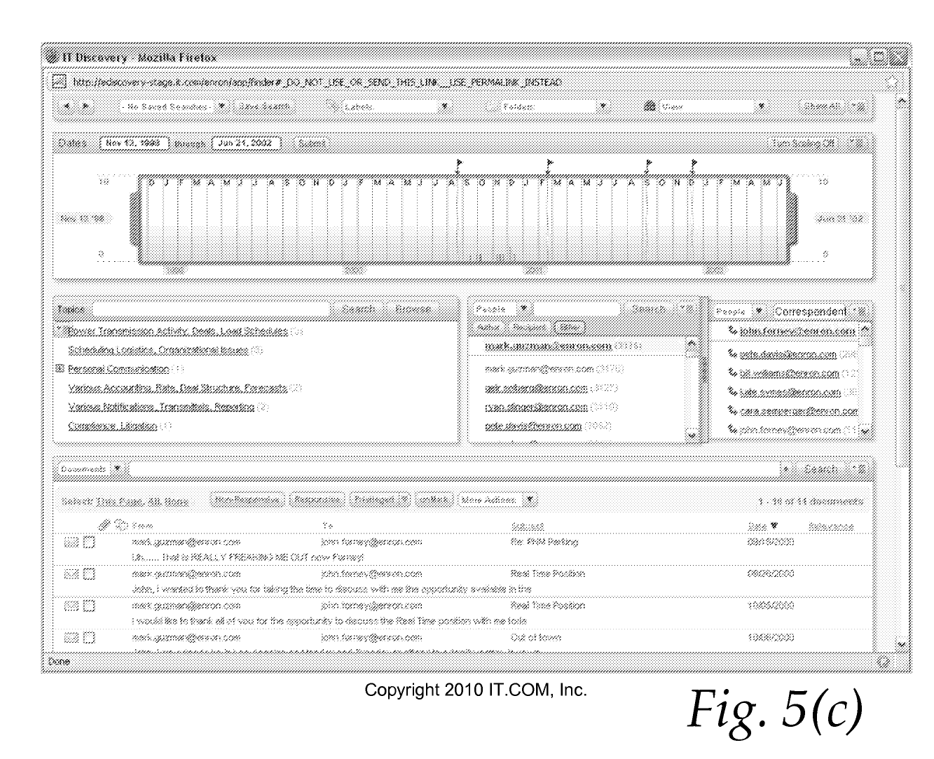

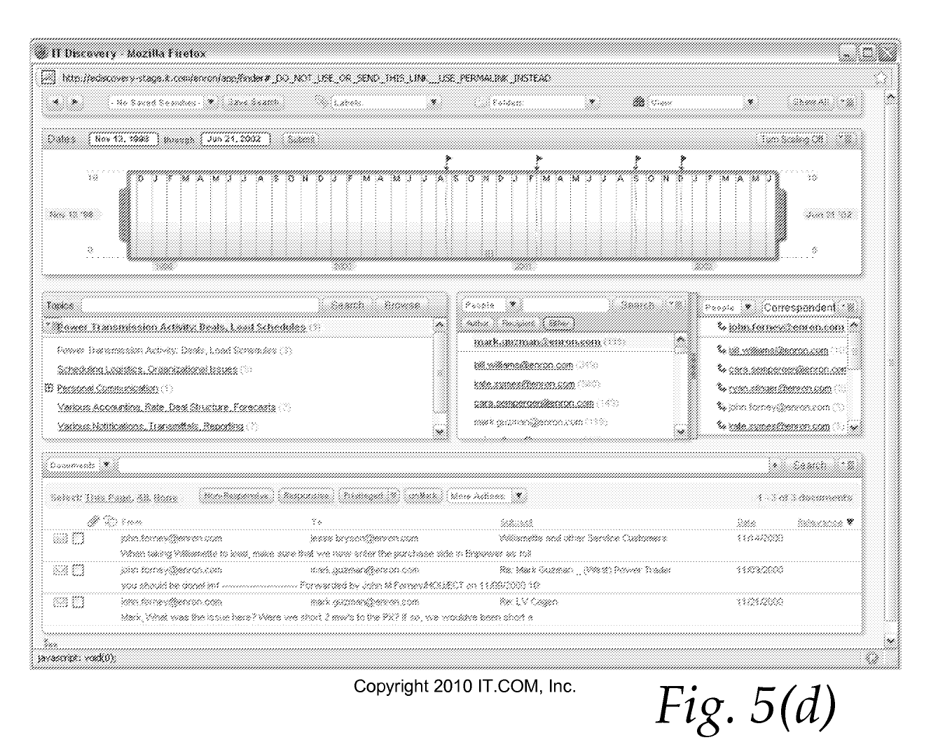

The Topic Region 304 also allows certain users to create new topics. Each topic listed in the Topic Region 304 also lists (in parentheses next to the topic name), the current number of data items (emails, documents, etc.) in the database that match that topic under the current search criteria. For example, as shown in FIG. 5(a), the topic labeled “Power Transmission Activity: Deals, Load Schedules” has 835 matching documents under the current search criteria (“Show All”). When the “People” selection is set to “mark.guzman@enron.com” (see FIG. 5(b)), there are only 119 matching documents under the topic labeled “Power Transmission Activity: Deals, Load Schedules”. In addition, the topic labeled “Power Transmission Activity: Deals, Load Schedules” has been moved up in the list of topics to reflect the number of documents matching the current search criteria for that topic. Note too that in FIG. 5(b) the timeline is updated to reflect the matching documents. Now, when the correspondent field is set to “john.forney@enron.com”, (see FIG. 5(c)) there are only three matching documents (emails) under the topic labeled “Power Transmission Activity: Deals, Load Schedules”. (The “correspondent” field reflects that the person was either the sender or recipient of the emails. The interface allows the user to specify which party was the sender or recipient.) FIG. 5(d) shows the results of searching the topic labeled “Power Transmission Activity: Deals, Load Schedules” for correspondence between “mark.guzman@enron.com” and “john.forney@enron.com”. The document region displays the three matching emails and the timeline reflects the search results.

A user with administrative rights can rename topics, merge topics, and delete topics.

To see the topic detail window, the user clicks the list icon next to the topic name. Two columns will appear, labeled “TOP WORDS” and “N-GRAMS.” The top words are those most closely associated with the topic in question, and not the most commonly used words in the topic.

The People Region 306 displays the people most prominent in the user's current search filters and orders the names to reflect those most relevant. A user can also start a new search in the People Region 306. When a name is selected in the People Region 306, the Topics Region 304 will display the topics most frequently associated with that person and the Document Region 308 will display documents and communication involving that person.

The Document Region 308 displays the emails and files that are relevant to a given topic and/or a particular person. The documents displayed are the result of all of the filters activated throughout the application (highlighted in melon).

A user can start a new search in the Document Region 308. Searches entered into this search box return results similar to traditional key word search—that is, ordered by relevance. The user can limit your search from the (default) all documents to “Only emails” or “Only files” at the dropdown menu to the left of the search field.

The user can use Boolean and other search operators to fine-tune a keyword search. When the user enters a keyword search in the document search field results displayed in the People Region 306 and Topics Region 304 are ranked to reflect the most relevant people and topics to a given document return set.

The Document region 308 includes a number of buttons to aid in document review and classification. One or more documents in the document region 308 may be selected (using the boxes on the left of the listing (see FIG. 3(a))), and classified, e.g., as “Non-Responsive”, “Responsive”, or “Privileged” (using the buttons 340, 342, 344 in FIG. 3). A document may be privileged for different reasons, and, as shown in FIG. 3(b), a drop down menu allows the user to set the reason (“Attorney-Client Communication” and/or “Attorney Work Product”).

The system 100 allows a user to produce lists of the documents based on their categorization. In this manner, a party to litigation can produce privilege logs and the like.

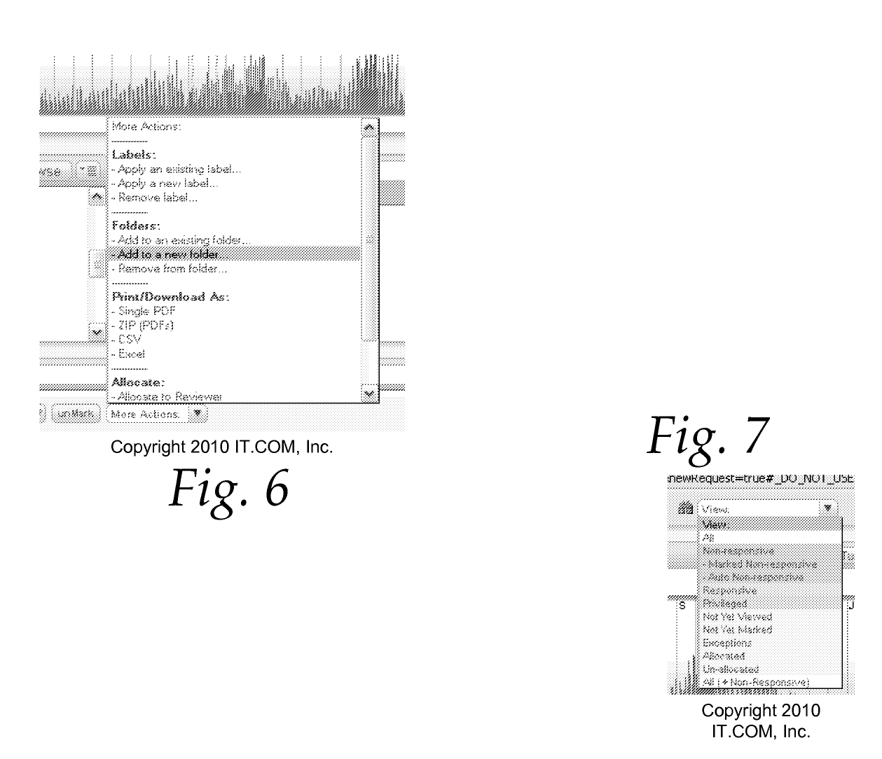

Another drop-down menu (346 in FIGS. 3(a), 4) allows users to take more actions on selected documents/emails. As shown in FIG. 6, the user may label a selection, add the selection to a folder, remove the selection from a folder, and print/download the selection in various forms. In addition, the user may allocate the selection to a particular reviewer.

The “View” control 316 allows the user to view documents based on various filters. As shown in FIG. 7 (which is a portion of the display showing the drop down menu selected using the “View” control 316), the user can view documents that are non-responsive, privileged, not yet viewed, not yet marked, allocated, un-allocated, and exceptions.

The user can add events to the timeline (shown as flags in the pictures). These events can be used to assist reviewers in adding temporal context to virtually any activity in the system, because one can visually see when a document was sent or created with respect to various important events.

Note that events added to the timeline by one user will be seen by other users of the system. Similarly, all users may see topics and labels. However, certain users may only be allowed to review and classify documents, and may not have permission to add topics or events.

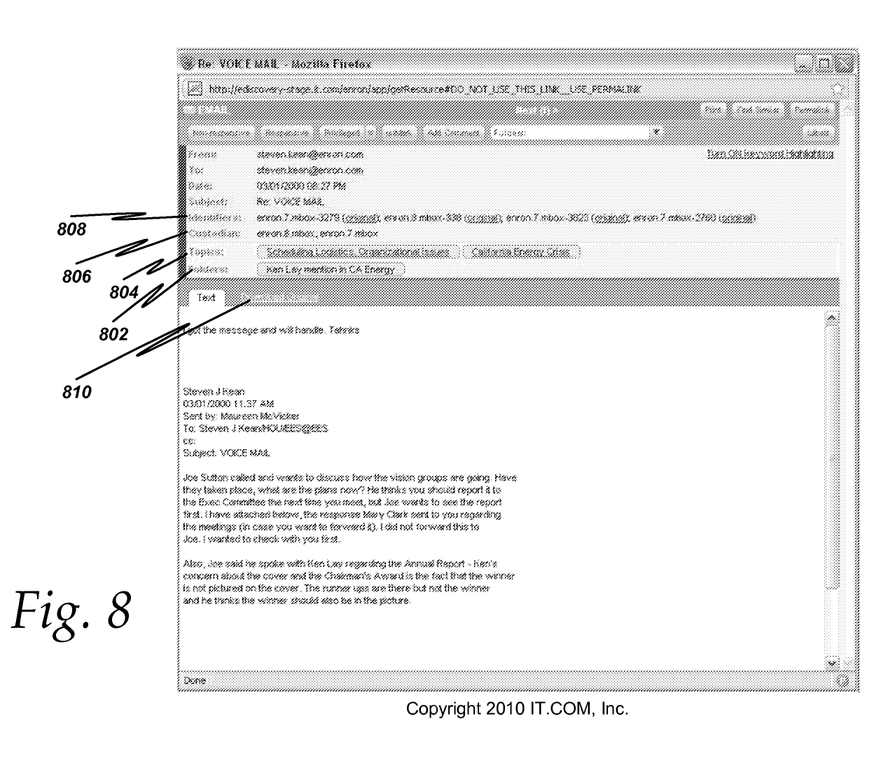

Selecting any document/email in the document region 308 causes that document to be displayed (preferably in a separate window). FIG. 8 shows an example document selected from the document region. As can be seen from the example in FIG. 8, the displayed document allows the user to see which folders the document is in (802 “on3p4g3”), under which topics the document is relevant (804), custodian information 806, and other identifiers 808. The user is also able to download a copy of the original document using the selector 810. In addition, the user has access to the various classification tools for this document using the buttons “Non-responsive”, “Responsive”, “Privileged,” etc.

It is sometimes desirable for a user to provide information to other reviewers. A user is able to send a link to a particular displayed search page by using the “Permalink” button in the drop-down menu 320 (FIG. 2(a)). This menu selection provides the user with a URL (Uniform Resource Locator) that can be sent to other users. The GUI described here presents, on a single page, temporal data, SNA-weighted topic information, sender/recipient metadata, file metadata, manual annotation metadata, machine learning classifier metadata.

Administration

An administrative module 113 (FIG. 1) allows the system 100 to be administered to control and track access to the data. Users can be given different roles (e.g., administrator, reviewer, etc.), with each role having different access rights within the system. The administrative module 113 also provides per-user reports, showing which documents each user reviewed, classified, printed, etc.

The implementation allows the system to be implemented at a very large scale and allows for distributed text extraction and distributed topic modeling across any number of computers. The system also supports distributed thread detection to identify conversations in email communications across an arbitrarily large number of computers (without relying on message-id information).

Distributed topic modeling achieves near-optimal SNA-weighted topics over a large number of computers.

A particular implementation of the system may support one or more of the following features:
Save and retrieve particular searches as a dynamic function; folder documents statically.
Move back and forth through recent search history
View discussion threads, and apply tagging, foldering, and annotation information to entire threads at once.
Display placeholders for “missing” email messages that weren't provided
Tag, folder, and add comments, and easily retrieve documents by any of those criteria
Search individual document fields like subject, body, and attachment type
Use advanced search operators for wildcard, proximity and phrase searches
Mass tagging, foldering, commenting, and annotation of documents
Arbitrary document allocation. Assign documents to specific users—who are only allowed to see documents they have been assigned. Allocations can be based on whatever search criteria you want, including topics, custodian, dates, and correspondents.

A current implementation of the system can process all common input formats (and many uncommon file types—nearly 400 of them), including:
Microsoft PST, MSG
Lotus NSF
Loose file types like DOC, XLS, PPT, etc
Standard mail formats like mbox, EML, and RFC822
Concordance and Summation load files

A current implementation of the system offers a variety of export formats, including:
Concordance
EML/RFC822
PDF
Native document
Plain text
XML

### Applications

Internal Investigations: At least since the new Federal Rules of Civil Procedure were adopted in December 2006, it has been necessary for corporate entities to be able to produce electronically stored information in the way such information is customarily kept. Compliance with regulations, however, is not simply a function of preserving documents, but also and especially of conforming to the substance of those regulations. The present system supports such compliance.

Litigation-related investigations and Discovery: It is well known that eighty percent of the cost of producing to the other party is the cost of Attorney time reviewing documents. The present invention reduces the cost of review by reducing the amount of time needed to review. One of the biggest problems in any large review set is getting rid of the vast amount of noise that constitutes a typical email inbox or file types that are, in a particular instance, necessarily non-responsive—these are the server alerts, jokes, and dinner plans that are usually of little importance to the investigation, but nevertheless managed to make it through the keyword, custodian and date filtering process. At the same time that it produces and hides the likely irrelevant material, the system produces and highlights the likely relevant material.

Culling: Cost savings in litigation is often a direct function of the amount to be reviewed by outside counsel, and the key is providing as little as possible to counsel for review, while, of course, providing as much as is legally necessary. The present system helps reduce the amount produced for review, and it makes the review by the law firm much more efficient.

Early Case Assessment: Once sued, it is generally impossible to assess liability without a good deal of knowledge. In a large company, nobody knows what every employee has done. Similarly, the degree of liability may be a potentially huge source of cost saving, allowing early settlement. Early case assessment is possible only with infrastructure at the ready to determine “what happened here” and therefore “what is my exposure”. The present system supports internal investigations at any time.

The methods of entering and display data take place on a single page interface, the integral nature of which reflecting the entire corpus or any part via selection criteria, and the interactive nature of any changes to any criteria being reflected on the same page instantaneously. This user interface is informed by SNA but also represents a complex set of rules of interactivity wherein the rank order of returns in each of the major sections of interface are at all times preserved, thus informing the user of things he may otherwise have missed, making “searching” as much “serendipitous discovery” as active command line queries.

Many governmental agencies have a need to do investigations and the system brings its same force to that task that it does for internal investigation of corporations. Additionally, there is the need, e.g., under FOIA, for the federal government to produce documents legally requested and falling under the statute as necessary to produce. This task can be monumental. With the present system, governmental agencies can have near real-time access to communication among them to respond inexpensively and immediately to such requests.

While the invention has been described as a web-based hosted system, those skilled in the art will understand, upon reading this description, that the system can be implemented fully (or in part) using an appliance.

Although aspects of this invention have been described with reference to a particular system, the present invention operates on any computer system and can be implemented in software, hardware or any combination thereof. When implemented fully or partially in software, the invention can reside, permanently or temporarily, on any memory or storage medium, including but not limited to a RAM, a ROM, a disk, an ASIC, a PROM and the like.

While certain configurations of structures have been illustrated for the purposes of presenting the basic structures of the present invention, one of ordinary skill in the art will appreciate that other variations are possible which would still fall within the scope of the appended claims. While the invention has been described in connection with what is presently considered to be the most practical and preferred embodiment, it is to be understood that the invention is not to be limited to the disclosed embodiment, but on the contrary, is intended to cover various modifications and equivalent arrangements included within the spirit and scope of the appended claims.

We claim:

1. A method, for use in a user computer system including a pointing device and a visual display unit, for providing a graphical user interface to a computer program for electronic discovery of information, wherein the information is stored in a database, and wherein the information has been preprocessed using a distributed Latent Dirichlet Allocation (LDA) approach and social network analysis (SNA) to find social network relationships and other metadata between items of the information, the method comprising:
displaying search criteria selectors on a screen of the visual display unit at the user's computer system;
in response to said displaying, obtaining specific search criteria from a user and providing the specific search criteria to the computer program;
the computer program accessing the information based on the user-specified specific search criteria, and
displaying in first area on a screen of the visual display unit at the user's computer system a graphical representation of a timeline, the timeline corresponding to the specific search criteria time;
displaying in a second area on the screen a list of one or more topics corresponding to the user-specified specific search criteria, wherein the topics were determined by a distributed LDA approach;
displaying in a third area on the screen a list of one or more people, the people in the list corresponding to the user-specified specific search criteria;
displaying in a fourth area on the screen a list of one or more documents, the documents corresponding to the user-specified specific search criteria; and
modifying at least some of the particular search criteria, and updating the first, second, third, and fourth areas of the screen in accordance with the modified search criteria.
